(19) United States
(12) Patent Application Publication
(10) Pub. No.: US 2025/0139841 A1
(43) Pub. Date: May 1, 2025

(54) SYSTEMS AND METHODS FOR MIXED REALITY APPLICATIONS WITH SELECTIVE FRAME TRANSMISSION

(71) Applicant: Toyota Motor Engineering & Manufacturing North America, Inc., Plano, TX (US)

(72) Inventors: Daniel Doe, San Jose, CA (US); Dawei Chen, Milpitas, CA (US); Kyungtae Han, Palo Alto, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/818,052

(22) Filed: Aug. 28, 2024

Related U.S. Application Data
(60) Provisional application No. 63/592,956, filed on Oct. 25, 2023.

(51) Int. Cl. G06T 11/00; G06F 3/01; G06T 9/00; G06V 20/20

(52) U.S. Cl. CPC G06T 11/00; G06F 3/012; G06F 3/013; G06T 9/00; G06V 20/20

(57) ABSTRACT

System and method for reducing latency and bandwidth usage include a reality device and one or more processors. The reality device includes a camera to operably capture a set of consequent frames of views external to a vehicle. The one or more processors are operable to select one or more frames of the set of consequent frames and skip rest of the set of consequent frames based on network quality metrics, user focus areas of a user, and a pending frame queue, and transmit the selected one or more frames to an edge server for performing a task on behalf of the vehicle.

This application claims priority to co-pending provisional U.S. Application No. 63/592,956, filed Oct. 25, 2023, which is incorporated herein by reference in its entirety.

### TECHNICAL FIELD

The present disclosure relates to systems and methods for mixed reality applications, more specifically, to systems and methods for mixed reality applications using remote computing technologies.

### BACKGROUND

Augmented reality (AR) technologies can be integrated into vehicle applications to enhance user interaction and mobility experiences. Remote AR data processing can release local AR computation usage and leverage cloud resources. Therefore, there is a need for a system and method for mixed reality (MR) applications that employ selective data transmission to balance the use of server resources for intensive processing tasks while maintaining network performance and cost-effectiveness.

### SUMMARY

In one embodiment, a system for reducing latency and bandwidth usage includes a reality device and one or more processors. The reality device includes a camera to operably capture a set of consequent frames of views external to a vehicle. The processors operably select one or more frames of the set of consequent frames and skip rest of the set of consequent frames based on network quality metrics, user focus areas of a user, and a pending frame queue, and transmit the selected one or more frames to an edge server for performing a task on behalf of the vehicle.

In another embodiment, a method for reducing latency and bandwidth usage includes selecting one or more frames of a set of consequent frames captured by a reality device and skipping rest of the set of consequent frames based on network quality metrics, user focus areas of a user, and a pending frame queue, and transmitting the selected one or more frames to an edge server for performing a task on behalf of the vehicle.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system for reducing latency and bandwidth usage in mixed reality (MR) usage of the present disclosure, according to one or more embodiments shown and described herewith;

FIG. 2 schematically depicts example components of the reality devices of the present disclosure, according to one or more embodiments shown and described herein;

FIG. 3 schematically depicts example components of the server of the present disclosure, according to one or more embodiments shown and described herein;

FIG. 4A schematically depicts an example system for performing selective frame transmission in mixed reality usage of the present disclosure, according to one or more embodiments shown and described herein

FIG. 4B schematically depicts a flowchart for performing selective frame transmission in MR usage of the present disclosure, according to one or more embodiments shown and described herein;

FIG. 5 depicts a sequence diagram for performing selective frame transmission in MR usage of the present disclosure, according to one or more embodiments shown and described herein; and

FIG. 6 depicts a flowchart for performing selective frame transmission in MR usage of the present disclosure, according to one or more embodiments shown and described herein.

### DETAILED DESCRIPTION

The systems and methods described herein are applicable to various simulation technologies, including, but not limited to, Augmented Reality (AR), Mixed Reality (MR), Extended Reality (XR or X-reality), holography (image overlay), and artificial intelligence (AI) in immersive virtual worlds. These systems and methods may use one or more local simulation devices, such as reality devices, in conjunction with one or more remote devices and/or servers. The reality devices can capture information about their surrounding environment, such as the environment around a user while driving a vehicle. They can process the environmental information and transfer the original and/or processed data to remote devices and/or servers. The remote devices and/or servers can perform tasks related to the received environmental information, such as object detection, and send the results back to the reality devices, the user's vehicle, and/or other electronic devices. The reality devices then integrate these results into the immersive virtual world.

The development of XR-integrated autonomous vehicles and AR technologies is revolutionizing mobility and user interaction experiences. Among the applications of AR technologies, real-time object detection is a desirable feature for MX applications in XR-integrated autonomous vehicles. These object detection tasks may involve context-sensitive driving, such as understanding the user's expectations when regularly looking at scenery, wildlife, or landmarks, providing real-time navigation assistance, and adjusting object detection based on the user's behavior and interactions with others in the vehicle.

Object detection tasks can be performed either locally on user devices or remotely on servers. Due to limitations in processing power, memory, and energy efficiency, processing AR data locally on reality devices may not always be feasible or desirable. Instead, server-based processing can manage computationally intensive tasks like object recognition, scene understanding, and spatial mapping. This remote processing leverages powerful cloud resources and advanced machine learning algorithms, allowing for real-time analysis and access to continually updated models and data.

However, remote XR-based object detection tasks must balance computational requirements and bandwidth usage. Current methods rely on transmitting full or substantial image frames to remote devices and servers, which is resource-intensive and leads to high bandwidth consumption and latency. These methods do not adapt to network conditions, resulting in delays and lags that degrade the user experience due to resource over-utilization. Further, information and outcomes may be transmitted between user reality devices and remote servers via wireless communication, where network congestion, signal strength, and interference from other devices can cause information latency.

To address the issues of latency and bandwidth usage, the disclosed system and method selectively transmit frames based on network conditions. By adapting to fluctuations in network quality during real-time MX experiences, this approach balances quality and efficiency, ensuring a high-quality MX experience while reducing resource usage. The system for reducing latency and bandwidth usage may include one or more reality devices and one or more processors. The reality devices may include one or more cameras to operably capture a set of consequent frames of views surrounding the reality devices or external to a vehicle. The processors may operably select one or more frames of the set of consequent frames and skip rest of the set of consequent frames based on network quality metrics, user focus areas of a user, and a pending frame queue, and transmit the selected one or more frames to a server for performing a task on behalf of the vehicle.

Various embodiments of the methods and systems for reducing latency and bandwidth usage in MX applications through selective frame transmission are described in more detail herein. Whenever possible, the same reference numerals will be used throughout the drawings to refer to the same or like parts.

As used herein, the singular forms “a,” “an” and “the” include plural referents unless the context clearly dictates otherwise. Thus, for example, reference to “a” component includes aspects having two or more such components unless the context clearly indicates otherwise.

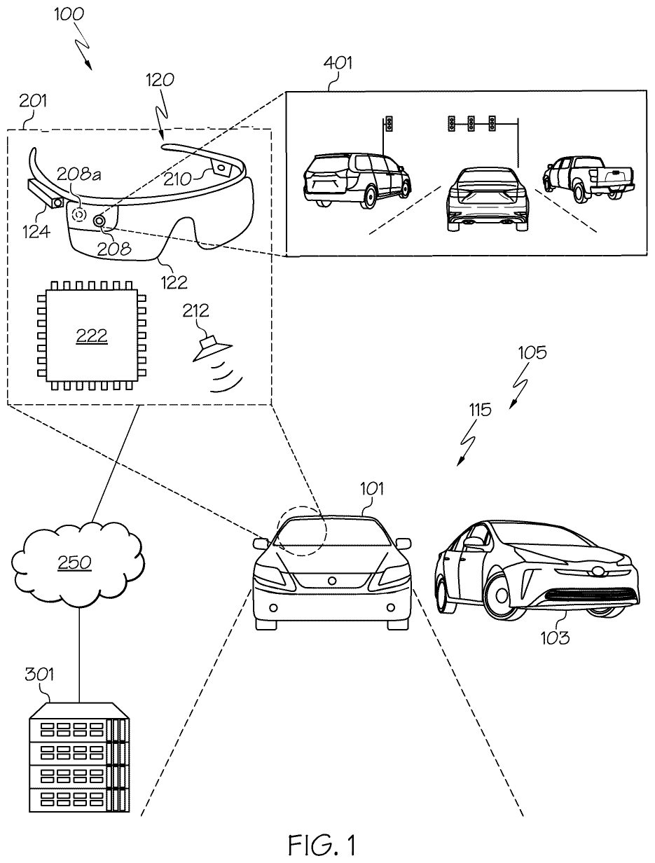

Referring now to Figures, FIG. 1 schematically depicts an example selective frame transmission system 100. The selective frame transmission system 100 includes components, devices, and subsystems based on MX-related and data-transmission-based technologies for information deployments during vehicle driving experiences. The MX technologies provide augmented and virtual reality experiences to one or more users (e.g., drivers and/or passengers) of an ego vehicle 101 to enhance situational awareness and entertainment during driving. The data transmission allows a real-time information flow to deliver information to the users in a timely and effective manner. Particularly, the selective frame transmission system 100 may capture images or frames 401 of environment 105 surrounding the ego vehicle 101 and transfer the images and frames 401 to one or more edge servers for task performance via wireless communication 250. The selective frame transmission system 100 may receive data transmitted from the server 301 (e.g., an edge server) and further integrate the received data into the MX function deployments.

The selective frame transmission system 100 may include one or more reality devices 201. The reality devices 201 are the local devices and components used by a user for the MX experience, such as while driving an autonomous vehicle. In some embodiments, the reality devices 201 may perform any MX-related functions to interact with the user to provide an immersive MX experience, without any assistance of external devices or cloud-based services. In some embodiments, the reality devices 201 may collaborate with external devices and services, such as the wireless communication 250 and the server 301, to enhance the MX experience for the user when local devices may be insufficient to perform the desirable tasks or provide desirable information.

In some embodiments, the reality devices 201 may include, without limitation, a virtual head unit 120, an adaptive framenet optimizer (AFNO) module 222, one or more sensors, such as a vision sensor 208, an eye-tracking sensor 208a, and a head-tracking sensor 210, a rendering device 124, a sound sensor 212, or a combination thereof. The eye-tracking sensor 208a may capture information regarding the user's eyes when the user wears the virtual head unit 120. The vision sensor 208 may operably capture environmental images or videos in consequence of one or more frames 401 of environment 105 around the user and/or the ego vehicle 101. The reality devices 201 may further include the network interface hardware 206 that can be communicatively coupled to a wireless communication 250 to transmit data to and/or from external computing resources, such as the server 301.

In some embodiments, the virtual head unit 120 may include, without limitations, the vision sensor 208, glasses 122, the eye-tracking sensor 208a, the head-tracking sensor 210, and the rendering device 124. The eye-tracking sensor 208a may operably track the user's eye movements. The eye-tracking sensor 208a may enable the selective frame transmission system 100 to understand where the user is looking for gaze-based interaction with virtual objects, adjust the level of operation of the system to improve performance and reduce computational load, and analyze the user's attention and interest. The head-tracking sensors 210 may track the user's head movement. The head-tracking sensor 210 may allow the selective frame transmission system 100 to understand the position and orientation of the user's head in physical space. The rendering devices 124, such as one or more projectors, may superimpose images or texts onto the user's eyes or an immersive screen, such as a see-through display or the glasses 122, to render the images or texts into the real-world view of the user.

In some embodiments, the vision sensor 208 may be operable to acquire image and video data, such as one or more frames 401, of the environment 105 surrounding the reality devices 201. The vision sensor 208 may include the eye-tracking sensor 208a operable to acquire images and video data of the user's eyes. The vision sensor 208 may be, without limitation, an RGB camera, a depth camera, an infrared camera, a wide-angle camera, or a stereoscopic camera. The vision sensor 208 may be equipped, without limitation, on a smartphone, a tablet, a computer, a laptop, the virtual head unit 120, or on the ego vehicle 101. In operation, the vision sensor 208 may continuously capture one or more frames 401 of the environment 105 surrounding the reality devices 201 or the ego vehicle 101.

In some embodiments, the selective frame transmission system 100 may include one or more displays. The display may be equipped, without limitation, on the ego vehicle 101, a touchscreen, a smartphone, a tablet, a computer, a laptop, or the virtual head unit 120. The captured frames or processed frames marked with detected objects with or without related information may be displayed on the displays.

In some embodiments, the vision sensor 208, the eye-tracking sensor 208a, the head-tracking sensor 210, and the rendering device 124 may be included in the ego vehicle 101. For example, the vision sensor 208, the eye-tracking sensor 208a, the head-tracking sensor 210, or the rendering device 124 may be mounted on a windshield, a steering wheel, a dashboard, or a rearview mirror of the ego vehicle 101.

In some embodiments, the selective frame transmission system 100 may include an interaction device. The interaction device may provide communication between the user and the virtual world. The interaction device may include a tangible object, such as, without limitations, a marker, a physical model, a sensor, a wearable motion-tracking device, or a smartphone.

In some embodiments, the selective frame transmission system 100 may include a sound sensor 212. The sound sensor 212 may operably determine the volume, pitch, frequency, and/or features of sounds in the ego vehicle 101 or around the virtual head unit 120. The sound sensor 212 may be embedded in the virtual head unit 120 or inside the ego vehicle 101 to detect and process the sound waves that are produced when the user or a passenger speaks in the ego vehicle 101. The selective frame transmission system 100 may include a speech processor to convert the sound waves into human language and further recognize the meaning within, such as user commands.

In some embodiments, the AFNO module 222 may include one or more processors communicatively coupled to other reality devices. The AFNO module 222 may receive data generated by one or more other reality devices 201, such as the image or video data generated by the vision sensor 208 and the eye-tracking sensor 208a, the sound data generated by the sound sensor 212, and the motion data generated by the head-tracking sensor 210. The AFNO module 222 may further inquire and receive information on external hardware and devices, such as the wireless communication 250 and the server 301. For example, the AFNO module 222 may inquire and receive real-time network quality metrics of the wireless communication 250, such as, without limitation, round-trip time, bandwidth, packet loss, network congestion, and error rate of data transmission. The AFNO module 222 may inquire and receive real-time pending task queues, such as a pending frame queue, at the server 301. The AFNO module 222 may determine a real-time user focus area of the user based on the eye-tracking data and the motion data.

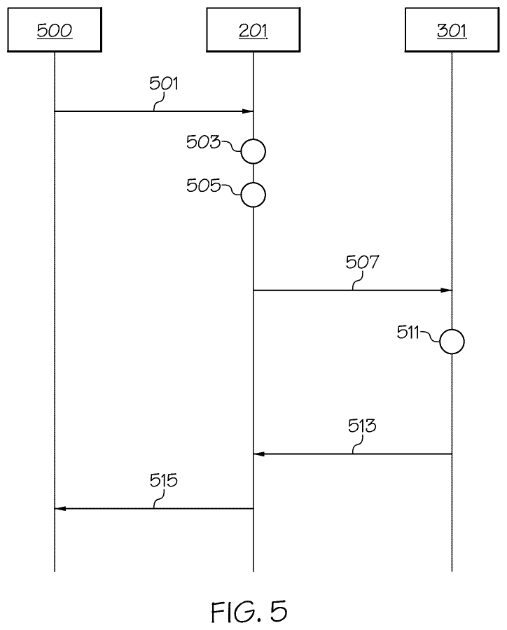

In some embodiments, the AFNO module 222 may determine whether to send the frames 401 to the server 301, and if yes, send which representative frames 403 (e.g., as illustrated in FIG. 5) represent a representative scene and change in the frames 401 to the server 301, and whether to further conduct frame compression to any of the representative frames 403, based on the network quality metrics of the wireless communication 250, the user's focus area, and the pending task queue of the server 301.

In some embodiments, the AFNO module 222 may include an artificial intelligence (AI) module including one or more AI algorithms. The AI module may be used to monitor the network quality and select one of the frames 401 for transmission. The AI module may include a deep reinforcement learning function. The deep reinforcement learning function may include determining the frame transmission, frame skipping, and frame compression, based on the network quality metrics, user's focus area, and pending frame queue. The AI algorithms may be trained based on the rewards of correct object detection that meets the user's demands, reduced bandwidth, and penalty for latency and missed object detection.

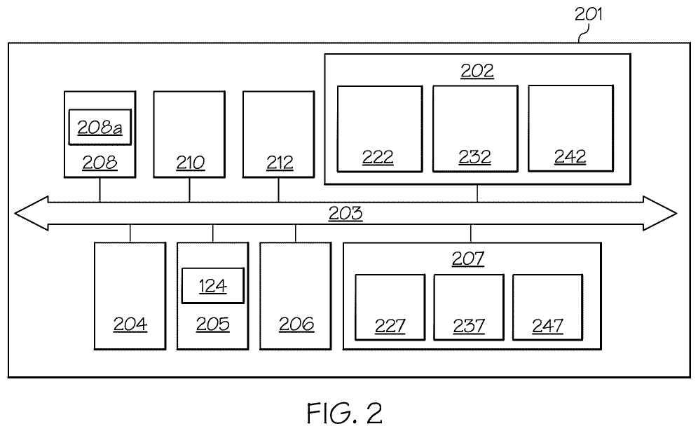

The selective frame transmission system 100 may include one or more processors (e.g., as illustrated in FIG. 2). The processor may be included, without limitation, in a controller (such as a computer, a laptop, a tablet, or a smartphone), the virtual head unit 120, a server, or a third-party electronic device.

The selective frame transmission system 100 may include the ego vehicles 101. In embodiments, each of the ego vehicles 101 may be an automobile or any other passenger or non-passenger vehicle such as, for example, a terrestrial, aquatic, and/or airborne vehicle. Each of the ego vehicles 101 may be an autonomous vehicle that navigates its environment with limited human input or without human input. Each of the ego vehicle 101 may drive on a road 115, where one or more non-ego vehicles 103 may share the road 115 with the ego vehicle 101. Each of the vehicles 101 and 103 may include actuators for driving the vehicle, such as a motor, an engine, or any other powertrain. The vehicles 101 and 103 may move or appear on various surfaces, such as, without limitation, roads, highways, streets, expressways, bridges, tunnels, parking lots, garages, off-road trails, railroads, or any surfaces where the vehicles may operate.

In embodiments, the vision sensors 208 may continuously capture frames of environment 105 surrounding the user and the ego vehicle 101, such as a non-ego vehicles 103 near the ego vehicle 101, objects in the environment 105 surrounding the ego vehicle, such as buildings, traffic lights, places of interests, contextual information, such as weather information, a type of the road on which the ego vehicle 101 is driving, a surface condition of the road 115 on which the ego vehicle 101 is driving, and a degree of traffic on the road 115 on which the ego vehicle 101 is driving. The environmental data may include buildings and constructions near the road 115, weather conditions (e.g., sunny, rain, snow, or fog), road conditions (e.g., dry, wet, or icy road surfaces), traffic conditions, road infrastructure, obstacles (e.g., non-ego vehicles 103 or pedestrians), lighting conditions, geographical features of the road 115, and other environmental conditions related to driving on the road 115.

In embodiments, the reality devices 201 may send a request of task performance and one or more frames 401 or selected frames 403 (e.g., as illustrated in FIG. 5) to the one or more servers 301. Each of the ego vehicle 101 may include a network interface hardware 206 and communicate with the server 301 via wireless communications 250. The ego vehicle 101 may transmit, without limitation, one or more frames 401, one or more selected frames 403 environmental data, sensory data, real-time driver reaction time, and one or more driver states associated with a current driver. In some embodiments, the ego vehicle 101 may communicate with the server 301 using a smartphone, a computer, a tablet, or a digital device that requires data processing.

In embodiments, the server 301 may be any device and/or edge server remotely connected to the reality devices 201. The server 301 may include, without limitation, one or more of cloud servers, smartphones, tablets, telematics servers, fleet management servers, connected car platforms, application servers, Internet of Things (IoTs) servers, or any server with the capability to transmit data with the reality devices 201. The server 301 may include server network interface hardware 306 and communicate with the reality devices 201, the ego vehicles 101, and other servers via wireless communications 250. The server 301 may include an object detection module 322 operable to analyze uploaded images and video frames to identify any objects of interest within the images and video frames and generate object detection data to send back to the reality devices 201 and/or the ego vehicle 101.

The wireless communication 250 may connect various components, the reality devices 201, the ego vehicle 101, and the server 301 of the selective frame transmission system 100, and allow signal transmission between the various components, the reality devices 201, the ego vehicles, and/or the server 301 of the selective frame transmission system 100. In one embodiment, the wireless communications 250 may include one or more computer networks (e.g., a personal area network, a local area network, or a wide area network), cellular networks, satellite networks, a global positioning system, and combinations thereof. Accordingly, the reality devices 201, the ego vehicles 101, and the servers 301 can be communicatively coupled to the wireless communications 250 via a wide area network, a local area network, a personal area network, a cellular network, or a satellite network, etc. Suitable local area networks may include wired Ethernet and/or wireless technologies such as Wi-Fi. Suitable personal area networks may include wireless technologies such as IrDA, Bluetooth®, Wireless USB, Z-Wave, ZigBee, and/or other near-field communication protocols. Suitable cellular networks include, but are not limited to, technologies such as LTE, WiMAX, UMTS, CDMA, and GSM.

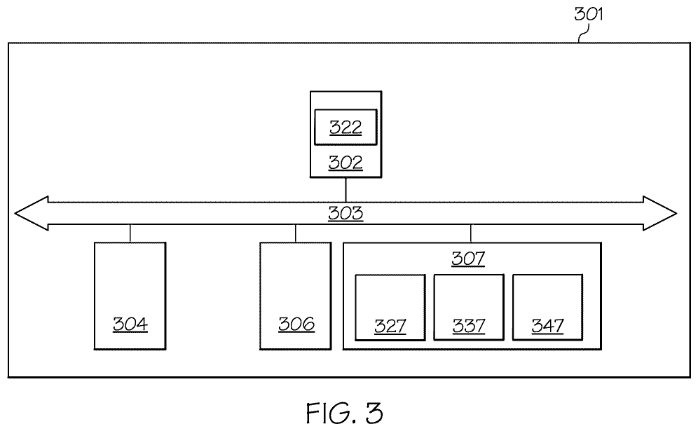

FIGS. 2 and 3 schematically depict example components of the selective frame transmission system 100. The selective frame transmission system 100 may include the one or more reality devices 201, the ego vehicle 101, and/or the server 301. While FIG. 2 depicts one reality device 201, more than one reality devices 201 may be included in the selective frame transmission system 100.

Referring to FIG. 2, the reality device 201 may include one or more processors 204. Each of the one or more processors 204 may be any device capable of executing machine-readable and executable instructions. The instructions may be in the form of a machine-readable instruction set stored in data storage component 207 and/or the memory component 202. Accordingly, each of the one or more processors 204 may be a controller, an integrated circuit, a microchip, a computer, or any other computing device. The one or more processors 204 are coupled to a communication path 203 that provides signal interconnectivity between various modules of the system. Accordingly, the communication path 203 may communicatively couple any number of processors 204 with one another, and allow the modules coupled to the communication path 203 to operate in a distributed computing environment. Specifically, each of the modules may operate as a node that may send and/or receive data. As used herein, the term “communicatively coupled” means that coupled components are capable of exchanging data signals with one another such as, for example, electrical signals via a conductive medium, electromagnetic signals via air, optical signals via optical waveguides, and the like.

Accordingly, the communication path 203 may be formed from any medium that is capable of transmitting a signal such as, for example, conductive wires, conductive traces, optical waveguides, or the like. In some embodiments, the communication path 203 may facilitate the transmission of wireless signals, such as WiFi, Bluetooth®, Near Field Communication (NFC), and the like. Moreover, the communication path 203 may be formed from a combination of mediums capable of transmitting signals. In one embodiment, the communication path 203 comprises a combination of conductive traces, conductive wires, connectors, and buses that cooperate to permit the transmission of electrical data signals to components such as processors, memories, sensors, input devices, output devices, and communication devices. Accordingly, the communication path 203 may comprise a vehicle bus, such as for example a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal wave, triangular wave, square-wave, vibration, and the like, capable of traveling through a medium.

The one or more memory components 202 may be coupled to the communication path 203. The one or more memory components 202 may comprise RAM, ROM, flash memories, hard drives, or any device capable of storing machine-readable and executable instructions such that the machine-readable and executable instructions can be accessed by the one or more processors 204. The machine-readable and executable instructions may comprise one or more logic or algorithms written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored on the one or more memory components 202. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 204 along with the one or more memory components 202 may operate as a controller or an electronic control unit (ECU) for the reality devices 201 and/or the ego vehicle 101.

The one or more memory components 202 may include the AFNO module 222, a user command module 232, and an eye/head tracking module 242. The data storage component 207 stores historical frame operation data 227, historical network/server data 237, and historical user interaction data 247. The historical frame operation data 227 may include historical frame cropping data and historical frame selection data. The historical user interaction data 247 may include, without limitations, historical user eye and/or head tracking data, historical user attention data, historical user voice command data, and historical user driving data.

The reality devices 201 may include the input/output hardware 205, such as, without limitation, a monitor, keyboard, mouse, printer, camera, microphone, speaker, and/or other device for receiving, sending, and/or presenting data. The input/output hardware 205 may include the rendering device 124. The rendering devices 124 is coupled to the communication path 203 and communicatively coupled to the one or more processors 204. The rendering device 124 may include, without limitations, a projector or a display. In some embodiments, the rendering device 124 may display digital content directly onto physical surfaces, such as the glass 122. For example, the rendering device may overlay navigation instructions onto the glass 122 or the road 115 while driving or display additional information regarding objects in the environment 105. In some embodiments, the rendering device 124 may project images directly onto the user's retina to create a blend of virtual and real-world visuals.

The reality device 201 may include network interface hardware 206 for communicatively coupling the reality device 201 to the server 301. The network interface hardware 206 can be communicatively coupled to the communication path 203 and can be any device capable of transmitting and/or receiving data via a network. Accordingly, the network interface hardware 206 can include a communication transceiver for sending and/or receiving any wired or wireless communication. For example, the network interface hardware 206 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 206 includes hardware configured to operate in accordance with the Bluetooth® wireless communication protocol. The network interface hardware 206 of the reality devices 201 and/or the ego vehicle 101 may transmit its data to the server 301 via the wireless communication 250. For example, the network interface hardware 206 of the reality devices 201 and/or the ego vehicle 101 may transmit original or processed frames 401 and other task related data to the server 301, and receive processed information, task performance results, and any relevant data, such as, without limitation, vehicle data, image and video data, object detection data, and the like from the server 301.

In some embodiments, the vision sensor 208 is coupled to the communication path 203 and communicatively coupled to the processor 204. The reality device 201 may include one or more vision sensors 208. The vision sensors 208 may be used for capturing images or videos of the environment 105 around the user and/or the ego vehicles 101. In some embodiments, the one or more vision sensors 208 may include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar may be used to obtain rough depth and speed information for the view of the reality devices 201 and/or the ego vehicle 101. The one or more vision sensors 208 may include a forward-facing camera installed in the reality devices 201 and/or the ego vehicle 101. The one or more vision sensors 208 may be any device having an array of sensing devices capable of detecting radiation in an ultraviolet wavelength band, a visible light wavelength band, or an infrared wavelength band. The one or more vision sensors 208 may have any resolution. In some embodiments, one or more optical components, such as a mirror, fish-eye lens, or any other type of lens may be optically coupled to the one or more vision sensors 208. In embodiments described herein, the one or more vision sensors 208 may provide image data to the one or more processors 204 or another component communicatively coupled to the communication path 203. In some embodiments, the one or more vision sensors 208 may also provide navigation support. That is, data captured by the one or more vision sensors 208 may be used to autonomously or semi-autonomously navigate a vehicle.

In some embodiments, the vision sensors 208 may include the eye-tracking sensor 208a. The eye-tracking sensor 208a may be a remote eye-tracking sensor positioned at a distance to track the user's eye movements without needing physical contact with the user, and/or a head-mounted eye-tracking sensor equipped on the virtual head unit 120 or a place inside the ego vehicle 101 that directly tracks eye movements. The eye-tracking sensor 208a may be an infrared-based eye-tracker that uses infrared light to detect the reflection from the retina and cornea to calculate the point of gaze. The eye-tracking sensor 208a may be a video-based eye-tracker that uses high-speed cameras to capture eye movements to determine gaze direction. The eye-tracking sensor 208a may be an electrooculography that measures the electrical potential around the user's eyes to infer movement and position.

In some embodiments, the head-tracking sensor 210 is coupled to the communication path 203 and communicatively coupled to the processor 204. The head-tracking sensor 210 may include an inertial sensor, an optical sensor, a magnetic sensor, an acoustic sensor, or a combination thereof. The head-tracking sensor 210 may operably monitor and measure the position and movement of the user's head. For example, in one embodiment, the head-tracking sensor 210 may include accelerometers and/or gyroscopes in the virtual head unit 120 to monitor the user's head movements. In another embodiment, the head-tracking sensor 210 may be a camera attached to the ego vehicle 101 to track the position and movement of the user's head.

In some embodiments, the sound sensor 212 is coupled to the communication path 203 and communicatively coupled to the processor 204. The sound sensor 212 may be one or more sensors coupled to the selective frame transmission system 100 for determining the volume, pitch, frequency, and/or features of sounds in the ego vehicle 101 or around the virtual head unit 120. The sound sensor 212 may include a microphone or an array of microphones that may include mechanisms to filter background noise, such as engine sounds or beamforming. The sound sensor 212 may be embedded in the virtual head unit 120 or inside the ego vehicle 101 to detect and process the sound waves that are produced when a person speaks in the vehicle. For example, the sound sensor 212 may be located in the ceiling, dashboard, or center console of the ego vehicle 101. The sound sensor 212 may be connected to one or more microphones picking up the soundwaves. The soundwaves may be then processed by the selective frame transmission system 100 which converts the soundwaves into digital signals.

Referring to FIG. 3, the server 301 includes one or more processors 304, one or more memory components 302, data storage component 307, server network interface hardware 306, and a local interface 303. The one or more processors 304 may be a controller, an integrated circuit, a microchip, a computer, or any other computing device. The one or more memory components 302 may comprise RAM, ROM, flash memories, hard drives, or any device capable of storing machine-readable and executable instructions such that the machine-readable and executable instructions can be accessed by the one or more processors 304. The one or more memory components 302 may include an object detection module 322. The data storage component 307 may store historical object detection data 327, historical user preference data 337, and object information data 347.

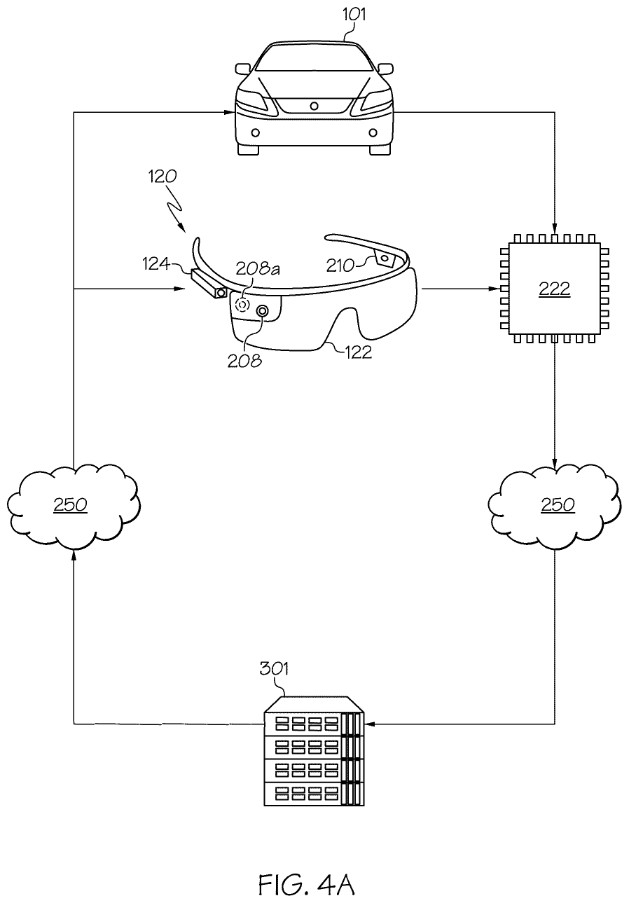

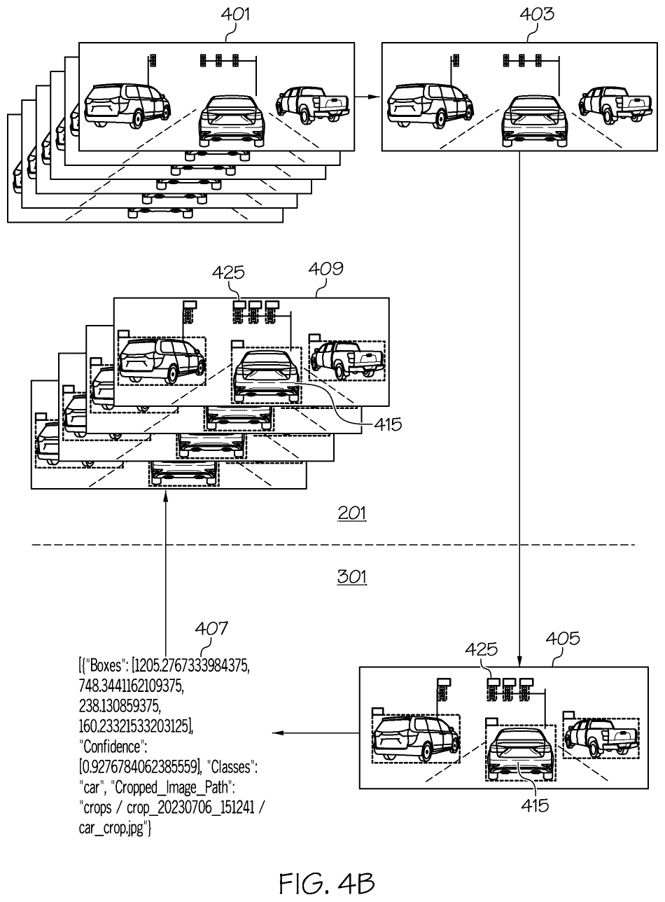

In some embodiments, the object detection module 322 may, after receiving an object detection task request and one or more selected frames 403 (e.g., in FIG. 4B) from the reality devices 201, normalize, resize, and adjust the received selected frames, use one or more object detection models, such as You Only Look Once (YOLO), Single Shot Multbox Detector (SSD), Region-based Convolutional Neural Networks (R-CNN) to generated model outputs, such as, without limitation, bounding boxes (e.g., coordinates of rectangles around detected objects), class labels (e.g., type of the object), and confidence scores for each detected object. In some embodiments, the object detection module 322 may further conduct non-maximum suppression to eliminate redundant overlapping boxes and apply a confidence score threshold to filter out low-confidence detections. The generated detection data, such as [{“Boxes”: [coordinate point 1, coordinate point 2, coordinate point 3, coordinate point 4], “Confidence”: [a value between 0 and 1], “Classes”: “object type”}], for each detected object, may be sent to the reality devices 201. The object detection and detection data transmission may consider other factors, such as the user's preference and past object detection.

Referring back to FIGS. 2 and 3, each of the reality device modules and the server modules, such as the AFNO module 222, the eye/head tracking module 242, the user command module 232, and the object detection module 322, may include one or more machine learning algorithms. The reality device modules and the server modules may be trained and provided with machine-learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In ML applications, new inputs may be provided (such as the generated one or more outputs) to the ANN model as training data to continue to improve accuracy and minimize error of the ANN model. The one or more ANN models may utilize one-to-one, one-to-many, many-to-one, and/or many-to-many (e.g., sequence-to-sequence) sequence modeling. The one or more ANN models may employ a combination of artificial intelligence techniques, such as, but not limited to, Deep Reinforcement Learning (DRL), Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in the field of machine learning, for example, is a class of deep, feed-forward ANNs applied for audio analysis of the recordings. CNNs may be shift or space-invariant and utilize shared-weight architecture and translation. Further, each of the various modules may include a generative artificial intelligence algorithm. The generative artificial intelligence algorithm may include a general adversarial network (GAN) that has two networks, a generator model and a discriminator model. The generative artificial intelligence algorithm may also be based on variation autoencoder (VAE) or transformer-based models.

Referring to FIGS. 4A, 4B, and 5, the selective frame transmission system 100 for reducing latency and bandwidth usage is depicted. The selective frame transmission system 100 may include one or more reality devices 201, including, without limitations, the vision sensor 208 operably capturing a set of consequent frames 401 of views external to the ego vehicle 101. The AFNO module 222 may inquire and receive the network quality metrics of the wireless communication 250 and a pending frame queue at the server 301. The eye/head tracking module 242 may determine the user focus areas of the user. The AFNO module 222 may select one or more representative frames 403 of the set of consequent frames 401 and skip the rest of the set of consequent frames 401 for transmission. The AFNO module 222 may further determine whether to compress one or more of the selected one or more frames 403 before transmission. The selective frame transmission system 100 may transmit the selected one or more frames 403, compressed or original, to the server 301, such as an edge server, a central server, a cloud server, or the like, for performing a task on behalf of the ego vehicle 101.

In some embodiments, in operation, the user may wear the one or more reality devices 201, such as the virtual head unit 120 while using or driving the ego vehicle 101. The vision sensor 208 on the virtual head unit 120 or the ego vehicle 101 may continuously capture images and/or image frames 401 of the environment 105 around the user and/or the ego vehicle 101. The AFNO module 222 may determine whether to transfer any captured frames 401 to the server 301 for image processing tasks, such as object detection, considering the local computing resources and efficiency, and the remote devices and network resources and efficiency.

In some embodiments, the AFNO module 222 may determine whether to transmit frames to the server based on the user's focus states, for example, using eye-tracking data and head-tracking data. The reality devices 201 may collect the eye-tracking data and the head-tracking data using the eye-tracking sensor 208a and the head-tracking sensor 210. The vision sensor 208 may work with the eye/head tracking module 242 and the user command module 232 to determine the states of the generated video frames and focus area. The eye/head tracking module 242 may utilize eye-tracking data from the eye-tracking sensor 208a and head-tracking data from the head-tracking sensor 210 to assess the user's focus area in the current frame and the interest in objects within the current frame. The eye/head tracking module 242 may estimate the level of interest by analyzing eye movement patterns such as fixation, saccades, skipping, and regression, alongside head orientation, head movements, and head stability. For example, the eye/head tracking module 242 may determine the area of interest in the current frame based on first fixation time and duration, number of fixations, number of visits, and total time spent.

Accordingly, the eye/head tracking module 242 may use the tracking analysis to determine whether the user focus areas in a corresponding frame of the set of consequent frames are at high-interest level, low-interest level, or off-interest level to the user. For example, the eye/head tracking module 242 may determine whether the user is at off-interest level (e.g., a fixation time of less than ˜100 ms) at the current frame. In response to determining that the user focus areas are off-interest to the user, the AFNO module 222 may skip the corresponding frame 401 from transmitting to the server 301. In one example, the eye/head tracking module 242 may determine whether the user is at low-interest level (e.g., a fixation time between ˜ 100 ms and ˜500 ms) in one current frame 401. In response to a determination that the user focus area in the current frame 401 is of low-interest level, the AFNO module 222 may skip or compress the corresponding frame from transmitting to the server 301. In one another example, the eye/head tracking module 242 may determine whether the user is at high-interest level (e.g., a fixation time more than ˜500 ms) in one current frame 401. In response to a determination that a high-interest focus area is included in the current frame 401, the AFNO module 222 may select the current frame 401 as one of the representative frames 403 to transmit to the server 301, without compression.

In some embodiments, the AFNO module 222 may determine whether the pending frame queue is beyond a pending threshold (e.g., 1000 pending frame queue or 5 s pending frame queue). The pending threshold may be determined based on the expected time to receive task results from the server 301. In response to determining that the pending frame queue is beyond the pending threshold, the AFNO module 222 may select one or more representative frames 403 of the set of consequent frames 401 and skip rest of the set of consequent frames 401. The representative frames 403 may represent a representative scene and change in the consequent frames 401. In some embodiments, the AFNO module 222 may further tune the selection level based on the network quality metrics of the wireless communication 250 and the pending frame queue at the server 301. For example, after acknowledging a high level of network congestion and a high volume of task queen at the server 301, the off-interest level, low-interest level, and high-interest level may be set to a raised fixation time threshold (e.g., to ˜300 ms, between ˜300 and ˜800 ms, and ˜800 ms, respectively).

In embodiments, the algorithms in the various modules in determining the selective frames may be pre-trained, tuned, and continuously trained via machine-learning functions within. For example, the AFNO module 222 may be a deep reinforcement learning-based (DRL-based) frame selector. The DRL agent may use neural networks to approximate the mapping between network states, user states (e.g., focus areas), and actions (e.g., uploading selective frames). The DRL agent learns from trial and error by selecting frames to be compressed, transmitted, or compressed and transmitted, observing the outcomes, and adjusting its policy to maximize the cumulative reward (such as user MR experience) over time.

In embodiments, the selective frame transmission system 100 may transmit the representative frames 403 and object detection task request to the server 301 through the wireless communications 250 (e.g., as illustrated in FIG. 1). The server 301 may feed the object detection module 322 with the task requirement in the objection detection task request and the representative frames 403. The object detection module 322 may perform the object detection using one or more object detection models, such as, without limitation, You Only Look Once (YOLO), Single Shot Multbox Detector (SSD), Region-based Convolutional Neural Networks (R-CNN) to detect the objects within each representative frame 403. In some embodiments, the object detection module 322 may personalize the object detection based on the request information, such as the user's preference, and past object detection, such as the historical object detection data 327, and historical user preference data 337. In some embodiments, the object detection module 322 may further conduct non-maximum suppression to eliminate redundant overlapping boxes and apply a confidence score threshold to filter out low-confidence detections. The object detection module 322 may generate object outputs 405, such as, without limitation, bounding boxes 415 (e.g., coordinates of polygons around detected objects), class labels (e.g., type of the object), and confidence scores for each detected object. For example, an object output may include detection data associated with an identified object, such as [{“Boxes”: [coordinate point 1, coordinate point 2, coordinate point 3, coordinate point 4], “Confidence”: [a value between 0 and 1], “Classes”: “object type”}].

In some embodiments, upon object detection, the server 301 may further retrieve object information 425 related to the detected objects from the object information data 347, other databases, or the Internet. The retrieved object information 425 may be included in the object outputs 405 to be sent to the reality devices 201 and/or the ego vehicle 101. For example, in one embodiment, the server 301 may recognize the object as a building that may be of interest to the user based on the user reference data. The server 301 may then retrieve relevant data of the building to be included in the object outputs associated with the building. In another embodiment, the server 301 may recognize the object as a vehicle with a plate number. The server 301 may search the plate number from a vehicle database and retrieve public information regarding the driver of the vehicle, such as, whether the driver has any traffic violations, and further to determine whether to include a warning in the object output associated with the vehicle.

In some embodiments, after the server 301 performs the requested object detection tasks, with optional detected objects information search and retrieval, the server 301 may select generated object detection data 407 to send to the one or more reality devices 201. The selected object detection data may include the bounding boxes, the class labels, the confidence scores, and the retrieved object information associated with the detected objects in the corresponding representative frames 403. The selected object detection data may exclude the received representative frames 403, whose file sizes are usually high in volume. The server 301 may then send the object detection data to the reality devices 201 and/or the ego vehicle 101 via the wireless communication 250.

In some embodiments, after receiving the object detection data, the reality devices 201 may superimpose the object detection data onto a real-world view 409 of the user. For example, the rendering device 124 may render the bounding boxes 415 and the retrieved object information 425 onto the glasses 122 to blend the information into the user's real-world view 409 in real-time.

In some embodiments, after receiving the object detection data, the ego vehicle 101 may be autonomously driven based on the object detection data. The selective frame transmission system 100 may create a real-time map of the environment 105 and implement a path planning algorithm to determine a desirable route or vehicle operation. The selective frame transmission system 100 may further control the steering, throttle, and braking system of the ego vehicle 101 and monitor the ego vehicle 101

Referring back to FIGS. 1-4B, in embodiments, the AFNO module 222 and the eye/head tracking module 242 may include one or more neural networks to train one or more AI algorithms within to select one or more frames of the set of consequent frames and skip rest of the set of consequent frames based on network quality metrics, user focus areas of a user, and a pending frame queue. The neural networks may include an encoder or/and a decoder conjunct with a layer normalization operation or/and an activation function operation. The encoded input data may be normalized and weighted through the activation function before being fed to the hidden layers. The hidden layers may generate a representation of the input data at a bottleneck layer. After delivering neural-network processed data to the final layer of the neural network, a global layer normalization may be conducted to normalize the output, such as predicted driver reaction time. The outputs may be normalized and converted using an activation function for training and verification purposes, as described in detail further below. The activation function may be linear or nonlinear. The activation function may be, without limitation, a Sigmoid function, a Softmax function, a hyperbolic tangent function (Tanh), or a rectified linear unit (ReLU). The neural networks may feed the encoder with historical frame operation data 227 and historical network/server data 237. The one or more neural networks may use regression techniques as described herein. The labeled driver data may be fed to the neural network to train the AFNO module 222 and the eye/head tracking module 242 to optimize the frame selection and transmission.

In some embodiments, the AFNO module 222 and the eye/head tracking module 242 may be pre-trained using training data, including ground-truth examples and scenarios where various entities, such as example reality devices 201, example ego vehicles 101, and example servers 301 are present in different example environments 105 at different network and task queue conditions, and may be used by various example users. The example users may exhibit various user preferences and user commands. The example environment 105 may include different objects that may be of interest to the example users. The pre-training may include labeling the entities, the example users, and example interested objects, and the environmental data in the examples and scenarios and using one or more neural networks to learn to predict the desirable and undesirable representative frames 403 based on the training data.

The pre-training may further include fine tuning, evaluation, and testing steps. The modules may be continuously trained using the real-world collected data to adapt to changing conditions and factors and improve the performance over time. For example, the neural network may be trained based on the activation functions mentioned further above. The encoder may generate encoded input data h=(Wx+b) that is transformed from the input data of one or more input channels. The encoded input data of one of the input channels may be represented as hᵢⱼ=g(Wxᵢⱼ+b) from the raw input data xᵢⱼ, which is then used to reconstruct output xᵢⱼ=f(W^{T}hᵢⱼ+b′). The neural networks may reconstruct outputs, such as generated object detection data 407, into x′=(W^{T}h+b′), where W is weight, b is bias, W^{T} and b′ are transverse values of W and b and are learned through backpropagation. In this operation, the neural networks may calculate, for each input data, a distance between an input data x and a reconstructed input data x′, to yield a distance vector |x-x′|. The neural networks may minimize the loss function which is a utility function as the sum of all distance vectors. The training process may enable the neural network to learn linear or non-linear representations of the input data.

The accuracy of the predicted output may be evaluated by satisfying a preset value, such as a preset accuracy and area under the curve (AUC) value computed using an output score from the activation function (e.g., the Softmax function or the Sigmoid function). For example, the selective frame transmission system 100 may assign the preset value of the AUC with the value of 0.7 to 0.8 as an acceptable simulation, 0.8 to 0.9 is as an excellent simulation, or more than 0.9 as an outstanding simulation. After the training satisfies the preset value, the updated neural networks may be stored in the various modules, which are used for future representative frames determination and transmission.

Referring to FIG. 5, a sequence diagram for performing selective frame transmission in reality usage is depicted. At block 501, a user 500 may wear the reality devices 201, such as the virtual head unit 120, while driving the ego vehicle 101. At block 503, the reality devices 201 may capture a set of consequent frames 401 of the environment 105 and capture eye movements and/or the head movements of the user 500. At block 505, the reality devices 201 may select one or more frames 403 of the set of consequent frames 401 and skip rest of the set of consequent frames 401 based on network quality metrics, user focus areas of the user 500, and a pending frame queue at the server 301. At block 507, the reality devices 201 may transmit the selected frames 403 to the server 301. At block 511, the server 301 may perform object detection on the selected frames 403 and generate object detection data. At block 513, the server 301 may send object detection data (e.g., bounding box info) back to the reality devices 201. At block 515, the reality devices 201 may render an MR environment with real-time object detection to the user 500. In embodiments, the reality devices 201 and the server 301 may perform continuous data exchange during user interaction. While FIG. 5 depicts performing object detection tasks, other tasks may be requested by the ego vehicle 101 and/or the reality devices 201, and performed by the server 301.

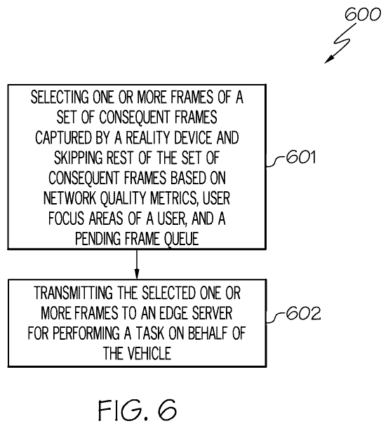

Referring to FIG. 6, a flowchart for illustrative steps for the method 600 for reducing latency and bandwidth usage of the present disclosure is depicted. At block 601, the present method 600 may include selecting one or more frames 403 of a set of consequent frames 401 captured by a reality device 201 and skipping rest of the set of consequent frames 401 based on network quality metrics, user focus areas of a user, and a pending frame queue. At block 602, the present method 600 may include transmitting the selected one or more frames 403 to a server 301, such as an edge server, for performing a task on behalf of the vehicle 101. In some embodiments, the network quality metrics may include round-trip time, bandwidth, packet loss, network congestion, error rate, or a combination thereof.

In some embodiments, the present method 600 may further include compressing one or more of the selected one or more frames 403 before transmitting to the edge server based on the network quality metrics and the pending frame queue.

In some embodiments, the present method 600 may further include determining whether the user focus areas in a corresponding frame of the set of consequent frames are off-interest to the user based on user eye movements and user head movements tracked by the reality device, and in response to determining that the user focus areas are off-interest to the user, skip the corresponding frame.

In some embodiments, the present method 600 may further include determining whether the pending frame queue is beyond a pending threshold, and in response to determining that the pending frame queue is beyond the pending threshold, selecting one or more representative frames of the set of consequent frames and skipping rest of the set of consequent frames, wherein the representative frames represent a representative scene and change in the consequent frames.

In some embodiments, the present method 600 may further include receiving object detection data from the edge server, and autonomously driving the vehicle based on the object detection data. The object detection data may include box cords of detected objects in the selected frames, confidence of each corresponding box cord, and object information of each detected object. The present method 600 may further include superimposing the object detection data onto a real-world view.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for reducing latency and bandwidth usage comprising:
a reality device comprising a camera to operably capture a set of consequent frames of views external to a vehicle; and
one or more processors operable to:
select one or more frames of the set of consequent frames and skip rest of the set of consequent frames based on network quality metrics, user focus areas of a user, and a pending frame queue; and
transmit the selected one or more frames to an edge server for performing a task on behalf of the vehicle.

2. The system of claim 1, wherein the one or more processors are further operable to compress one or more of the selected one or more frames before transmitting to the edge server based on the network quality metrics and the pending frame queue.

3. The system of claim 1, wherein the reality device further comprises an eye-tracking sensor operable to track user eye movements, and a head-tracking sensor operable to track user head movements; and
the one or more processors are further operable to:
determine whether the user focus areas in a corresponding frame of the set of consequent frames are off-interest to the user based on the user eye movements and the user head movements; and
in response to determining that the user focus areas are off-interest to the user, skip the corresponding frame.

4. The system of claim 1, wherein the one or more processors are further operable to:
determine whether the pending frame queue is beyond a pending threshold; and
in response to determining that the pending frame queue is beyond the pending threshold, select one or more representative frames of the set of consequent frames and skip rest of the set of consequent frames, wherein the representative frames represent a representative scene and change in the consequent frames.

5. The system of claim 1, wherein the network quality metrics comprise round-trip time, bandwidth, packet loss, network congestion, error rate, or a combination thereof.

6. The system of claim 1, wherein the one or more processors are further operable to:
determine whether the network quality metrics are greater than a network traffic threshold; and
in response to determining that the network quality metrics are greater than the network traffic threshold, select one or more representative frames of the set of consequent frames and skip rest of the set of consequent frames, wherein the representative frames represent a representative scene and change in the consequent frames.

7. The system of claim 1, wherein the one or more processors are further operable to receive object detection data from the edge server.

8. The system of claim 7, wherein the one or more processors are further operable to autonomously drive the vehicle based on the object detection data.

9. The system of claim 7, wherein the object detection data comprises box cords of detected objects in the selected frames, confidence of each corresponding box cord, and object information of each detected object.

10. The system of claim 7, wherein the one or more processors are further operable to superimpose the object detection data onto a real-world view.

11. The system of claim 10, wherein the object detection data are superimposed onto a vision of a user or a current frame.

12. A method for reducing latency and bandwidth usage comprising:
selecting one or more frames of a set of consequent frames captured by a reality device and skipping rest of the set of consequent frames based on network quality metrics, user focus areas of a user, and a pending frame queue; and
transmitting the selected one or more frames to an edge server for performing a task on behalf of a vehicle.

13. The method of claim 12, wherein the method further comprises compressing one or more of the selected one or more frames before transmitting to the edge server based on the network quality metrics and the pending frame queue.

14. The method of claim 12, wherein the method further comprises:
determining whether the user focus areas in a corresponding frame of the set of consequent frames are off-interest to the user based on user eye movements and user head movements tracked by the reality device; and
in response to determining that the user focus areas are off-interest to the user, skipping the corresponding frame.

15. The method of claim 12, wherein the method further comprises:
determining whether the pending frame queue is beyond a pending threshold; and
in response to determining that the pending frame queue is beyond the pending threshold, selecting one or more representative frames of the set of consequent frames and skipping rest of the set of consequent frames, wherein the representative frames represent a representative scene and change in the consequent frames.

16. The method of claim 12, wherein the network quality metrics comprise round-trip time, bandwidth, packet loss, network congestion, error rate, or a combination thereof.

17. The method of claim 12, wherein the method further comprises:
determining whether the network quality metrics are greater than a network traffic threshold; and
in response to determining that the network quality metrics are greater than the network traffic threshold, selecting one or more representative frames of the set of consequent frames and skipping rest of the set of consequent frames, wherein the representative frames represent a representative scene and change in the consequent frames.

18. The method of claim 12, wherein the method further comprises:
receiving object detection data from the edge server; and
autonomously driving the vehicle based on the object detection data.

19. The method of claim 18, wherein the object detection data comprises box cords of detected objects in the selected frames, confidence of each corresponding box cord, and object information of each detected object.

20. The method of claim 18, wherein the method further comprises superimposing the object detection data onto a real-world view.
